(19) United States
(12) Patent Application Publication
(10) Pub. No.: US 2005/0252112 A1
(43) Pub. Date: Nov. 17, 2005

(54) J-channel and siding boards attachment structure

(75) Inventor: Akihiro Yoshida, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NICHIHA CO., LTD, Nagoya-shi (JP)

(21) Appl. No.: 11/129,438

(22) Filed: May 16, 2005

(30) Foreign Application Priority Data
May 17, 2004 (JP) 2004-146418

(51) Int. Cl. E06B 3/26

(52) U.S. Cl. 52/202

(57) ABSTRACT

The invention provides an inexpensive J-Channel which is excellent in a constructing property and a general-purpose property, and a siding boards attachment structure using the same. The invention provides a J-Channel configured to be arranged so as to cover an end portion of a siding board. The J-Channel comprises a fixing plate portion configured to be fixed to a backing of the siding board, and a movable front surface plate portion assembled in the fixing plate portion so as to be slidable forward and backward. The fixing plate portion comprises a rear surface portion and a coupling portion. The movable front surface plate portion comprises a front surface portion and a slide portion. The coupling portion and the slide portion are engaged in a state in which they are slidable with each other.

### CROSS-REFERENCES TO RELATED APPLICATIONS

The present application claims priority under 35 U.S.C. §119 to Japanese Patent Application No. 2004-146418, filed May 17, 2004, entitled “J-CHANNEL AND SIDING BOARDS ATTACHMENT STRUCTURE”. The contents of this application are incorporated herein by reference in their entirety.

### BACKGROUND OF THE INVENTION

1. Field of the Invention

The present invention relates to a J-Channel employed for a board siding so as to cover an end portion of a siding board. The present invention also relates to a siding boards attachment structure using the J-Channel.

2. Discussion of the Background

In related arts, conventionally, a J-Channel is used so as to cover an end portion of a siding board, for example, a top portion of the siding board arranged in a portion under eaves of the building. The J-Channel is formed in approximately J-shaped cross section having a front surface portion, a rear surface portion and a top surface portion connecting the front surface portion and the rear surface portion, and a concave portion is formed by those three surface portions. And an end portion of a siding board is accommodated in the concave portion. By using J-Channel, an external wall appearance is improved, and a rain water penetration from the end portion of a siding board, for example, ceramic siding board, is improved.

A opening width of the concave portion in J-Channel is decided according to a thickness of a siding board adopted. So it is necessary to prepare some J-Channels having various opening width for several siding boards to be employed. Consequently, it causes the high total cost of members for construction.

In the Patent Document 1, a J-Channel for a top portion of a siding board is disclosed. By the J-Channel, it is possible to accommodate several siding boards having various width. But the J-Channel consists of two joint-parts, and its joint-mechanism is complicated, so it causes the high cost for the J-Channel. Further, since two members are used, the structure is not necessarily advantageous in the light of a constructing property.

Furthermore, it is possible to use only at the under eaves of the building.

Patent Document 1: JP 1999-107508 Unexamined Patent Publication (Kokai)

### SUMMARY OF THE INVENTION

The present invention has been made in view of overcoming the aforementioned problems that may be high production cost, lack of a constructing property and restriction of arranging location. Therefore, an object of the present invention is to provide a J-Channel which is inexpensive because of its easy construction and is possible to use in several board sidings to be employed.

Another object of the present invention is to provide a siding boards attachment structure using the J-Channel.

According to a first aspect of the present invention, there is provided a J-Channel formed in approximately J-shaped cross section and configured to be arranged so as to cover an end portion of a siding board: comprising
a fixing plate portion having an approximately L-shaped cross section; and
a movable front surface plate portion assembled in the fixing plate portion so as to be slidable forward and backward and having an approximately L-shaped cross section;
wherein the fixing plate portion comprises a rear surface portion and a coupling portion provided so as to bend forward from the rear surface portion,
wherein the movable front surface plate portion comprises
a front surface portion and a slide portion provided so as to bend backward from the front surface portion, and
wherein the coupling portion and the slide portion are engaged in a state in which they are slidable with each other.

A description is given next of an operation and effect of the present invention.

The J-Channel is constituted by the fixing plate portion, and the movable front surface plate portion assembled in the fixing plate portion so as to be slidable forward and backward. Accordingly, it is possible to easily adjust the concave portion formed between the rear surface portion of the fixing plate portion and the front surface portion of the movable front surface plate portion to a proper width according to a thickness of the siding board or the like received in the J-Channel. Accordingly, it is not necessary to prepare various J-Channels for according to the siding board or the like having the various thickness, and it is possible to reduce a member cost.

Further, since the fixing plate portion and the movable front surface plate portion are both formed in the approximately L-shaped cross section, it is possible to easily form the both, for example, in accordance with a bending process of a steel plate. Accordingly, it is possible to reduce a manufacturing cost and a member cost. Further, since the fixing plate portion and the movable front surface plate portion are engaged with each other in the coupling portion and the slide portion, the fixing plate portion and the movable front surface plate portion are in an integrally formed state. Therefore, since the J-Channel can be handled as an integral product at a time of constructing, a constructing property is improved.

Further, the J-Channel has an approximately J-shaped cross section, which is constituted by the member obtained by combining two members having an approximately L-shaped cross section, and does not have any particularly complicated shape. Accordingly, the arranged position is not limited to the eave top portion or the like, and the J-Channel can be arranged at various positions in a building. Therefore, the J-Channel is excellent in the general-purpose property.

As mentioned above, in accordance with the present invention, it is possible to provide an inexpensive J-Channel which is excellent in a constructing property and a general-purpose property.

According to a second aspect of the present invention, there is provided a siding boards attachment structure having siding boards fastened to an underlayment, and a J-Channel arranged so as to cover an end portion of the siding board, wherein the J-Channel is formed in approximately J-shaped cross section and comprises a fixing plate portion having an approximately L-shaped cross section, and a movable front surface plate portion assembled in the fixing plate portion so as to be slidable forward and backward and having an approximately L-shaped cross section, the fixing plate portion comprises a rear surface portion and a coupling portion provided so as to bend forward from the rear surface portion, the movable front surface plate portion comprises a front surface portion and a slide portion provided so as to bend backward from the front surface portion, and the coupling portion and the slide portion are engaged in a state in which they are slidable with each other, and
wherein the rear surface portion of the fixing plate portion is arranged in a rear surface of the underlayment, and the front surface portion of the movable front surface plate portion is arranged in a front surface of an end portion of the siding board.

The siding boards attachment structure is formed by arranging the inexpensive J-Channel which is excellent in the constructing property and the general-purpose property, as mentioned above.

Therefore, in accordance with the present invention, it is possible to provide the inexpensive external wall structure which is excellent in the constructing property.

### BRIEF DESCRIPTION OF THE DRAWINGS

A more complete appreciation of the invention and many of the attendant advantages thereof will become readily apparent with reference to the following detailed description, particularly when considered in conjunction with the companying drawings, in which:

FIG. 1 is a perspective view of a J-Channel in a state in which a width of a concave portion is made largest in accordance with an embodiment 1;

FIG. 2 is a perspective view of the J-Channel in a state in which the width of the concave portion is made smallest in accordance with the embodiment 1;

FIG. 3 is a perspective view of a fixing plate portion and a movable front surface plate portion in accordance with the embodiment 1;

FIG. 4 is a cross sectional view of a siding boards attachment structure in the case that a width of a furring strip is small, in accordance with the embodiment 1;

FIG. 5 is a cross sectional view of the siding boards attachment structure in the case that the width of the furring strip is large, in accordance with the embodiment 1;

FIG. 6 is a perspective view of the siding boards attachment structure in accordance with the embodiment 1;

FIG. 7 is a perspective view of a state in which a J-Channel is arranged in an opening portion of a building, in accordance with the embodiment 1;

FIG. 8 is a perspective view of the siding boards attachment structure in the opening portion of the building, in accordance with the embodiment 1;

FIG. 9 is a perspective view of a siding boards attachment structure in which a J-Channel is arranged in an external corner portion, in accordance with an embodiment 2;

FIG. 10 is a longitudinal sectional view of a siding boards attachment structure in which a J-Channel is arranged between siding boards having different thicknesses, in accordance with an embodiment 3; and

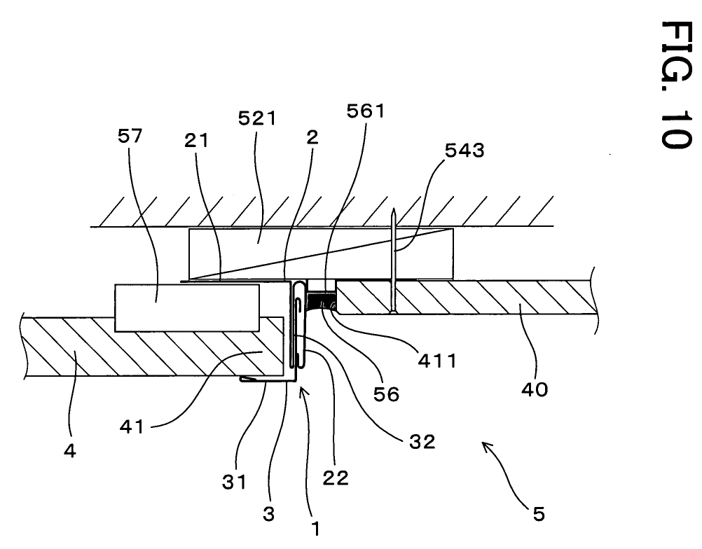

FIG. 11 is a longitudinal sectional view of a siding boards attachment structure in which a J-Channel is arranged between different kinds of external walls, in accordance with an embodiment 4.

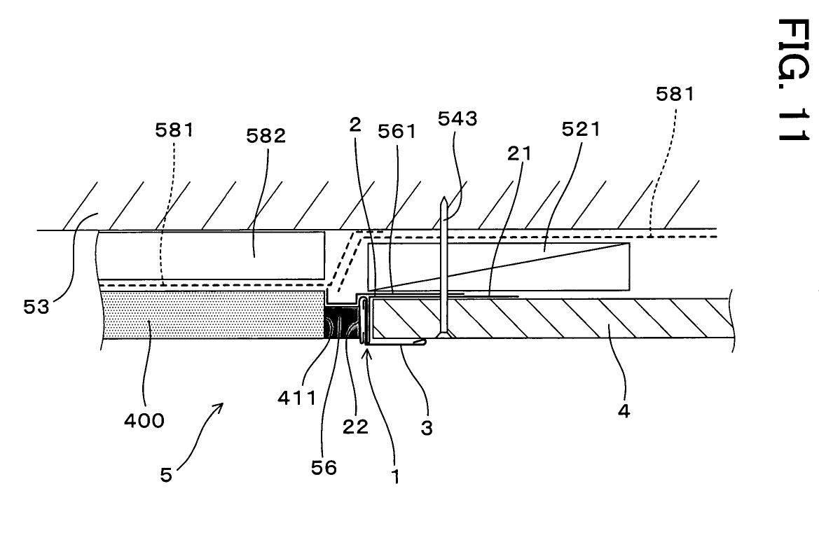

### DESCRIPTION OF THE PREFERRED EMBODIMENTS

In the first aspect mentioned above or the second aspect mentioned above, the J-Channel can be arranged, for example, at an eave top portion of the building, around an opening portion such as a window, a meter box or the like, an external corner portion, a joint portion between different kinds of siding boards, or the like. Further, the J-Channel can be arranged in any end portion such as an upper end portion, a lower end portion, a side end portion and the like of the siding board.

Further, the J-Channel can be manufactured, for example, by bending a galbarium steel plate, a gal tight steel plate or the like.

Further, the J-Channel can be employed in any case of a new construction and a reform.

In this case, in the present specification, a description is given by setting an outer direction of the building to “front” and an inner direction thereof to “rear”. A description is given of the J-Channel by respectively setting the outer direction of the building and the inner direction thereof to “front” and “rear” in a constructed state.

Further, it is preferable that any one of the coupling portion and the slide portion has a holding portion holding one of the coupling portion and the slide portion into another.

In this case, it is easy to make the coupling portion and the slide portion in the engaged state.

Further, it is preferable that each of the coupling portion and the slide portion is provided with a hook portion formed by bending a leading end so as to prevent them from being detached from each other.

In this case, it is possible to prevent the fixing plate portion and the movable front surface plate portion from being detached, and it is possible to easily handle the J-Channel at a time of constructing.

Further, it is preferable that the J-Channel has a fixing means for fixing the fixing plate portion and the movable front surface plate portion to each other.

In this case, it is possible to keep a width of the concave portion formed between a rear surface portion of the fixing plate portion and a front surface portion of the movable front surface plate portion constant at a time of arranging the J-Channel in the end portion of the siding board.

As the fixing means, for example, an adhesive tape, a sealing agent or the like can be employed.

Further, in the second aspect mentioned above, it is preferable that the J-Channel fixes the fixing plate portion and the movable front surface plate portion to each other by a fixing means.

In this case, in the J-Channel arranged in the end portion of the siding board, it is possible to keep a width of a concave portion formed between the rear surface portion of the fixing plate portion and the front surface portion of the movable front surface plate portion constant.

### Embodiment 1

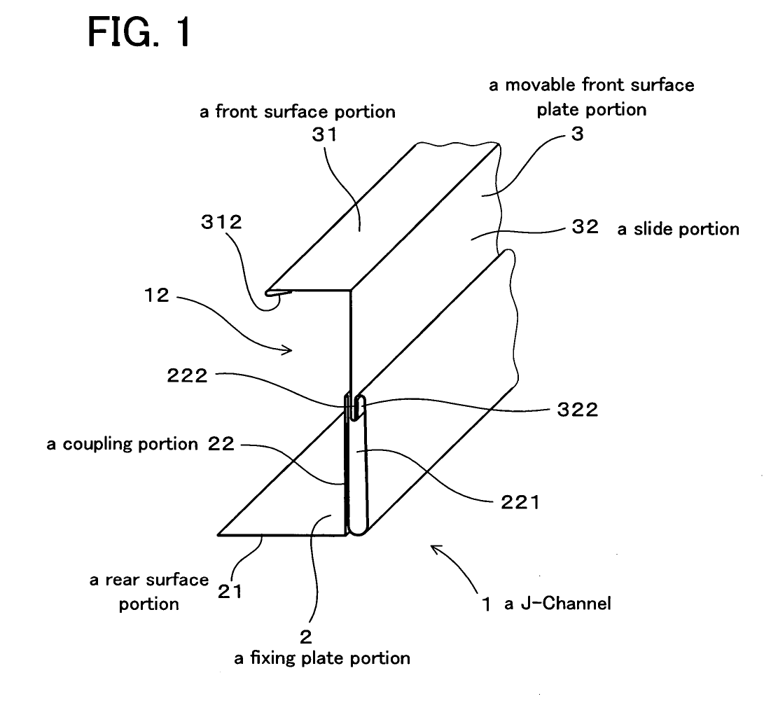

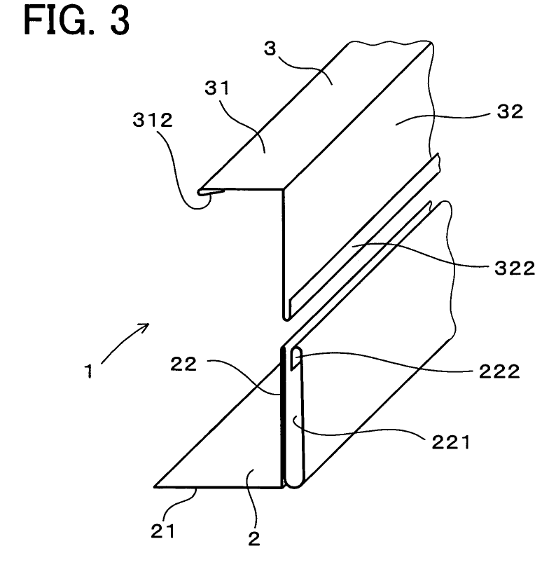

A description is given of a J-Channel and a siding boards attachment structure using the same in accordance with an embodiment of the present invention with reference to FIGS. 1 to 8.

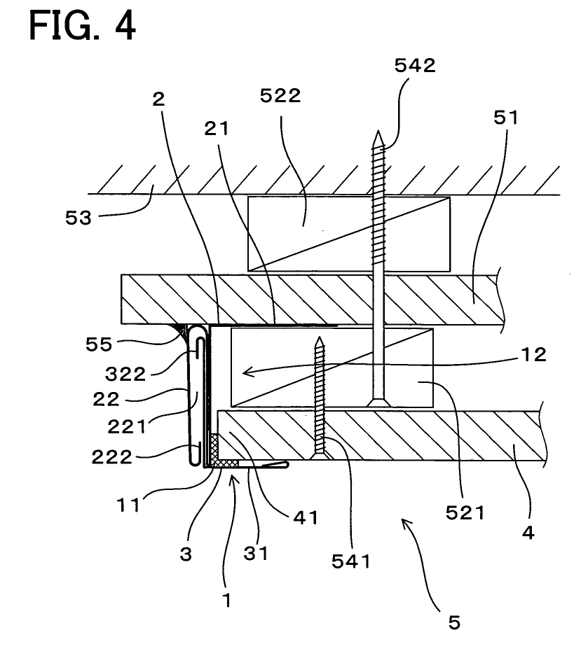

A J-Channel 1 in accordance with the present embodiment is formed in approximately J-shaped cross section and configured to be arranged so as to cover an end portion 41 of a siding board 4 as shown in FIGS. 4 to 6.

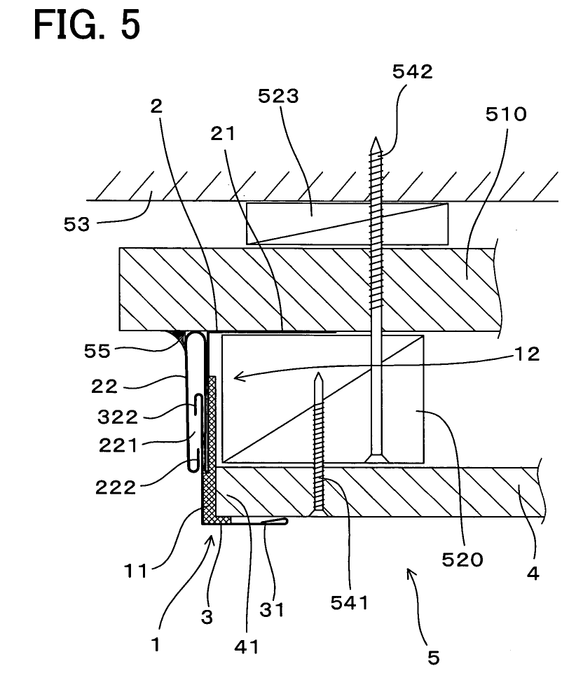

The J-Channel 1 is constituted by a fixing plate portion 2 configured to be fixed to an existing wall 51 (refer to FIGS. 4 and 5) being a backing of the siding board 4 and having an approximately L-shaped cross section, and a movable front surface plate portion 3 assembled in the fixing plate portion 2 so as to be slidable forward and backward and having an approximately L-shaped cross section, as shown in FIGS. 1 to 3.

The fixing plate portion 2 is constituted by a rear surface portion 21 configured to be arranged in a rear side of the siding board 4, and a coupling portion 22 provided so as to bend forward from the rear surface portion 21.

The movable front surface plate portion 3 is constituted by a front surface portion 31 configured to be arranged in a front surface of an end portion 41 of the siding board 4, and a slide portion 32 provided so as to bend rearward from the front surface portion 31.

The coupling portion 22 and the slide portion 32 are engaged with each other in a slidable state.

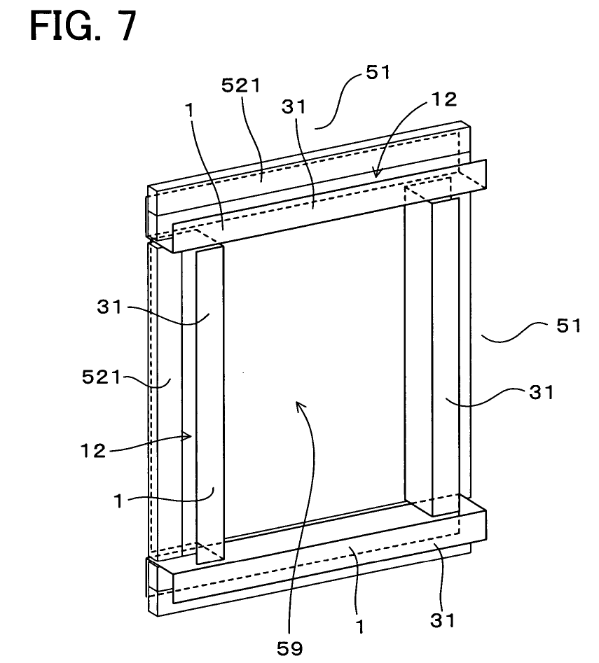

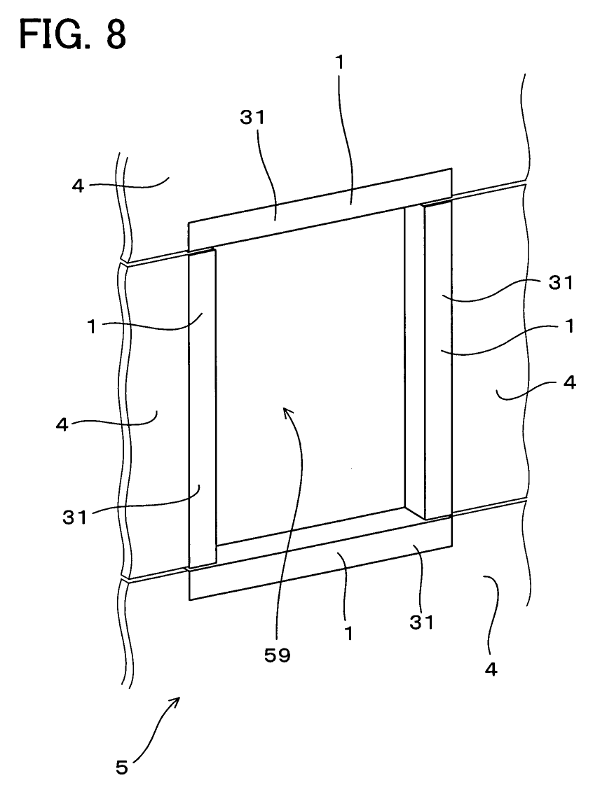

The J-Channel 1 in accordance with the present embodiment can be arranged around an opening portion 59 such as a window of a building, a meter box attaching portion or the like, as shown in FIGS. 7 and 8. In this case, in FIGS. 7 and 8, the J-Channel 1 is described in a simplified manner. Further, the J-Channel 1 can be arranged in any end portion 41 such as an upper end portion, a lower end portion, a side end portion of the like of the siding board 4. Further, the J-Channel 1 can be arranged in the end portion 41 of the siding board 4 which is newly placed at a time of reforming.

Further, the J-Channel 1 can be easily manufactured, for example, by bending a gal barium steel plate.

The coupling portion 22 has a holding portion 221 for holding the slide portion 32 as shown in FIGS. 1 to 3. The holding portion 221 can be formed by folding back a steel plate structuring the coupling portion 22 in an approximately N-shaped cross section at two times. Further, a hook portion 222 is formed by further folding back an end portion of the steel plate to an inner side (a rear surface portion 21 side). The hook portion 222 becomes in a state in which the hook portion 222 can be engaged with a hook portion 322 provided in the slide portion 32 as shown in FIG. 1, thereby having a function of preventing the coupling portion 22 and the slide portion 32 from being detached from each other.

The hook portion 322 provided in the slide portion 32 is formed by folding back a steel plate to an outer side (an opposite side to the front surface portion 31) in an end portion of the slide portion 32.

Further, a reinforcing fold-back portion 312 is provided in an end portion of the front surface portion 31 of the movable front surface plate portion 3.

Further, as shown in FIGS. 4 and 5, the J-Channel 1 has a fixing means 11 for fixing the fixing plate portion 2 and the movable front surface plate portion 3 to each other with a suitable parting width. An adhesive tape is used as the fixing means 11 and is stuck from an inner side of the J-Channel 1. Further, an end portion 41 of the siding board 4 is constructed so as to be brought into contact with the fixing means 11. In accordance with this structure, when the fixing means 11 has a waterproof property, it is possible to prevent a rain water from making a penetration from a portion between the J-Channel 1 and the siding board 4.

A description is given of a siding boards attachment structure 5 using the J-Channel 1 with reference to FIGS. 4 to 8.

The siding boards attachment structure 5 is structured such that a new siding board 4 for reform is fastened to an existing wall 51 via a furring strip 521 by a screw 541. The existing wall 51 is fixed to a framework 53 via a furring strip 522 by a screw 542.

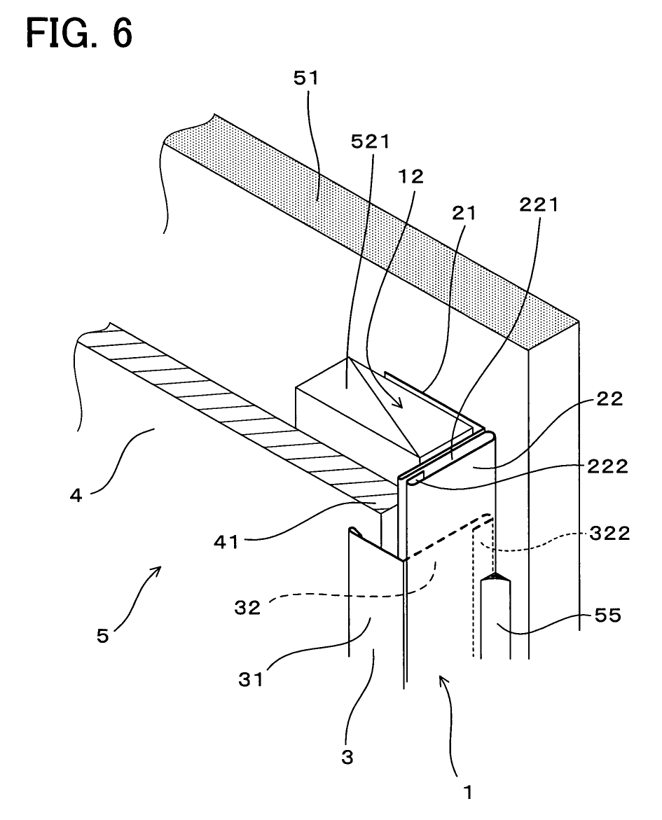

As shown in FIGS. 4 and 6, the J-Channel 1 is arranged so as to cover the end portion 41 of the siding board 4. In other words, the rear surface portion 21 of the fixing plate portion 2 in the J-Channel 1 is arranged between the existing wall 51 and the furring strip 521 arranged in the front surface thereof. Further, the front surface portion 31 of the movable front surface plate portion 3 of the J-Channel 1 is arranged in the front surface of the siding board 4. Further, the adhesive tape serving as the fixing means 11 is stuck from an inner side over the coupling portion 22 of the fixing plate portion 2 and the slide portion 32 of the movable front surface plate portion 3.

Further, a sealing agent 55 for preventing a water leakage is placed between the coupling portion 22 and the existing wall 51.

The J-Channel 1 is arranged around the opening portion 59 of the building as shown in FIG. 8, and is arranged in the end portion 41 of the siding board 4 toward the opening portion 59. In other words, it is arranged such as to cover the end portion 41 of the siding board 4 which is exposed in the case that the J-Channel 1 is not provided.

In the case of structuring the siding boards attachment structure 5, the J-Channel 1 is first fixed to the existing wall 51 in the rear surface portion 21 of the fixing plate portion 2 together with the furring strip 521, as shown in FIG. 7. The construction is executed in four sides including an upper side, a lower side, a left side and a right side of the opening portion 59.

Next, a longitudinal width (a parting width) of the concave portion 12 between the front surface portion 21 and the rear surface portion 31 is adjusted to a proper width by sliding the movable front surface plate portion 3 of the J-Channel 1 with respect to the fixing plate portion 2. The proper width means such a width that the furring strip 521 and the end portion 41 of the siding board 4 are received in the concave portion 12, and approximately corresponds to a total thickness of the furring strip 521 and the siding board 4.

Next, the movable front surface plate portion 3 and the fixing plate portion 2 are fixed to each other by the fixing means 11.

Next, as shown in FIGS. 4, 6 and 8, the siding board 4 is fixed to the existing wall 51 via the furring strip 521 while the end portion 41 of the siding board 4 is fitted to the concave portion 12 of the J-Channel 1.

As mentioned above, it is necessary to adjust the longitudinal width of the concave portion 12 of the J-Channel 1 in some thickness of the furring strip 521 and the siding board 4. For example, in the case of arranging the new siding board 4 for reform in the existing wall 510 made of a mortar as shown in FIG. 5, it is necessary to use the furring strip 520 having a large thickness. In this case, it is necessary to enlarge the longitudinal width of the concave portion 12 of the J-Channel 1, and the J-Channel 1 is used in a state of sliding the movable front surface plate portion 3 forward with respect to the fixing plate portion 2.

In this case, the existing wall 510 made of the mortar shown in FIG. 5 is fixed to the framework 53 via a wooden lath 523.

Further, the structure is made such that the longitudinal width of the concave portion 12 in the J-Channel 1 can be adjusted in a region between 30 and 60 mm.

Next, a description is given of an operation and effect of the present embodiment.

The J-Channel 1 is constituted by the fixing plate portion 2 and the movable front surface plate portion 3 assembled in the fixing plate portion 2 so as to be slidable forward and backward. Accordingly, as shown in FIGS. 4 and 5, it is possible to easily adjust the concave portion 12 formed between the rear surface portion 21 of the fixing plate portion 2 and the front surface portion 31 of the movable front surface plate portion 3 to the proper width according to the thicknesses of the siding board 4 and the furring strips 521 and 520 received in the J-Channel 1. Accordingly, it is not necessary to prepare various J-Channels according to the siding board 4, the furring strips 521 and 520 and the like having various thicknesses, and it is possible to reduce a member cost.

Further, the fixing plate portion 2 and the movable front surface plate portion 3 are both formed in the approximately L-shaped cross section, and can be easily formed in accordance with a bending process of a steel plate. Accordingly, it is possible to reduce a manufacturing cost and the member cost. Further, since fixing plate portion 2 and the movable front surface plate portion 3 are engaged with each other in the coupling portion 22 and the slide portion 32, the fixing plate portion 2 and the movable front surface plate portion 3 are in an integrally formed state. Accordingly, since the J-Channel 1 can be handled as an integrally formed product at a time of constructing, a constructing property is improved.

Further, the J-Channel 1 has an approximately J-shaped cross section, which is constituted by a member formed by combining two members having an approximately L-shaped cross section, and does not have any particularly complicated shape. Accordingly, an arranged position is not limited to the eave top portion or the like, and the J-Channel 1 can be arranged at various positions in the building. Accordingly, the J-Channel 1 is excellent in a general-purpose property.

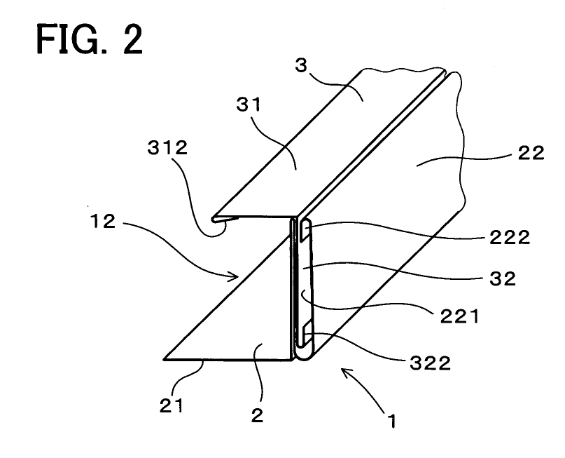

Further, since the coupling portion 22 has a holding portion 221 for holding the other, it is easy to make the coupling portion 22 and the slide portion 32 in an engaged state, as shown in FIGS. 1 and 2.

Further, since the coupling portion 22 and the slide portion 32 are respectively provided with the hook portions 222 and 322, it is possible to prevent the fixing plate portion 2 and the movable front surface plate portion 3 from being easily detached, as shown in FIG. 1, and it is possible to easily handle the J-Channel 1 at a time of constructing.

Further, the J-Channel 1 can keep the width of the concave portion 12 formed between the rear surface portion 21 of the fixing plate portion 2 and the front surface portion 31 of the movable front surface plate portion 3 constant at a time of arranging the J-Channel 1 in the end portion 41 of the siding board 4, as shown in FIGS. 4 to 6, by using the fixing means 11.

As mentioned above, in accordance with the present embodiment, it is possible to provide the inexpensive J-Channel which is excellent in the constructing property and the general-purpose property, and the siding boards attachment structure using the same.

### Embodiment 2

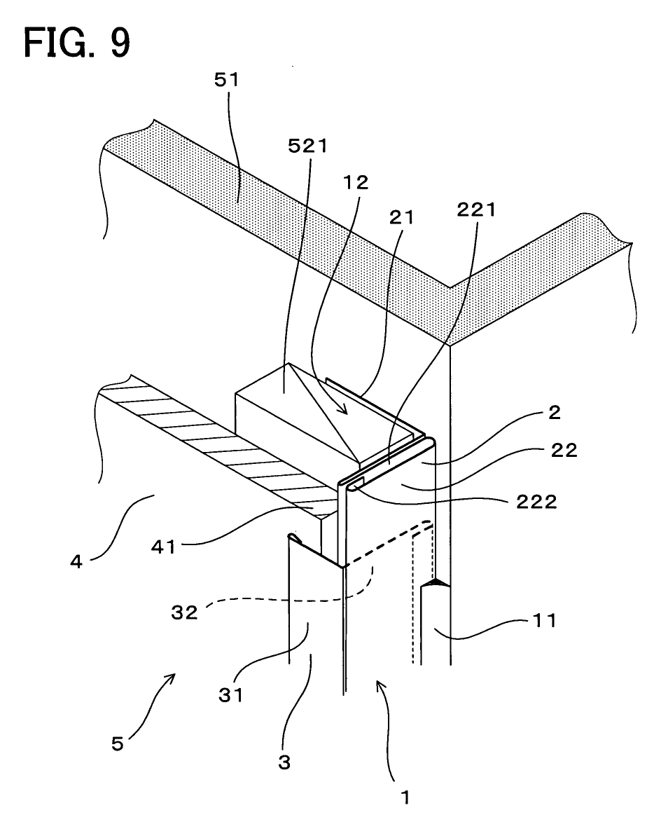

The present embodiment corresponds to an example in which the J-Channel 1 is arranged in the end portion 41 of the siding board 4 arranged in the external corner portion of the building, as shown in FIG. 9.

There is a case that the siding board 4 is cut for adjusting the size and a cut surface is exposed, even in the external corner portion. The J-Channel 1 in accordance with the present invention is arranged so as to cover the end portion 41 having the cut surface.

The other structures are the same as the embodiment 1, and the same operation and effect as those of the embodiment 1 are provided.

### Embodiment 3

The present embodiment corresponds to an example in which the J-Channel 1 is arranged in a joint portion of the siding boards 4 having different thicknesses.

In the siding boards attachment structure 5 in accordance with the present embodiment, the siding board 4 having a larger thickness and the siding board 40 having a smaller thickness than the siding board 4 are arranged adjacently, and a joint filler 56 is placed therebetween. Further, a single hut joiner 561 is arranged in a rear side of the joint filler 56.

The siding board 4 having the larger thickness is fastened to the furring strip 521 by a fastening fitting 57, and the siding board 40 having the smaller thickness is fastened to the furring strip 521 by a nail 543.

Further, the J-Channel 1 is arranged so as to cover the end portion 41 of the siding board 4 having the larger thickness. Further, the rear surface portion 21 of the fixing plate portion 2 of the J-Channel 1 is arranged between the fastening fitting 57 and the furring strip 521.

The joint filler 56 is placed between a side end surface 411 of the siding board 40 and the coupling portion 22 of the fixing plate portion 2 of the J-Channel 1, and prevents the water leakage.

The other structures are the same as the embodiment 1.

In the case of the present embodiment, it is possible to easily and securely place the joint filler 56 in the joint portion between the siding boards 4 and 40 having the different thicknesses. Further, it is possible to improve an outer appearance design property in the joint portion mentioned above.

In addition, the same operation and effect as those of the embodiment 1 can be obtained.

### Embodiment 4

The present embodiment corresponds to an example in which the J-Channel 1 is arranged in a joint portion between different kinds of external walls.

In other words, for example, one external wall can be constituted by a ceramic siding board 4 (a siding wall) and the other external wall is constituted by a mortar wall 400.

Further, the J-Channel 1 is arranged so as to cover the end portion 41 of the siding board 4.

Further, the siding board 4 is fixed to the framework 53 via a waterproof paper 581 and a furring strip 521 by a nail 543. The mortar wall 400 is arranged in a front surface of a wooden lath 582 via the waterproof paper 581. The waterproof paper 581 is also arranged in a rear side of the furring strip 521.

Further, the joint filler 56 is placed between the side end surface 411 of the mortar wall 400 and the coupling portion 22 of the fixing plate portion 2 of the J-Channel 1 by using the single hut joiner. Further, the rear surface portion 21 of the fixing plate portion 2 of the J-Channel 1 is arranged between the furring strip 521 and the siding board 4, and is fixed to the furring strip 521 by the nail 543.

The others are the same as the embodiment 1.

In the case of the present embodiment, it is possible to secure an excellent outer appearance design property in the joint portion of the different kinds of external walls.

In addition, the same operation and effect as those of the embodiment 1 can be obtained.

Obviously, numerous modifications and variations of the present invention are possible in light of the above teachings. It is therefore to be understood that, within the scope of the appended claims, the invention may be practiced otherwise than as specifically described here.

1. A J-Channel formed in approximately J-shaped cross section and configured to be arranged so as to cover an end portion of a siding board: comprising
a fixing plate portion having an approximately L-shaped cross section; and
a movable front surface plate portion assembled in the fixing plate portion so as to be slidable forward and backward and having an approximately L-shaped cross section;
wherein the fixing plate portion comprises a rear surface portion and a coupling portion provided so as to bend forward from the rear surface portion,
wherein the movable front surface plate portion comprises a front surface portion and a slide portion provided so as to bend backward from the front surface portion, and
wherein the coupling portion and the slide portion are engaged in a state in which they are slidable with each other.

2. A J-Channel as claimed in claim 1, wherein any one of the coupling portion and the slide portion has a holding portion holding one of the coupling portion and the slide portion into another.

3. A J-Channel as claimed in claim 1, wherein each of the coupling portion and the slide portion is provided with a hook portion formed by bending a leading end so as to prevent them from being detached from each other.

4. A J-Channel as claimed in claim 1, wherein the J-Channel has a fixing means for fixing the fixing plate portion and the movable front surface plate portion to each other.

5. A siding boards attachment structure having siding boards fastened to an underlayment, and a J-Channel arranged so as to cover an end portion of the siding board,
wherein the J-Channel is formed in approximately J-shaped cross section and comprises a fixing plate portion having an approximately L-shaped cross section, and a movable front surface plate portion assembled in the fixing plate portion so as to be slidable forward and backward and having an approximately L-shaped cross section, the fixing plate portion comprises a rear surface portion and a coupling portion provided so as to bend forward from the rear surface portion, the movable front surface plate portion comprises a front surface portion and a slide portion provided so as to bend backward from the front surface portion, and the coupling portion and the slide portion are engaged in a state in which they are slidable with each other, and
wherein the rear surface portion of the fixing plate portion is arranged in a rear surface of the underlayment, and the front surface portion of the movable front surface plate portion is arranged in a front surface of an end portion of the siding board.

6. A siding boards attachment structure as claimed in claim 5, wherein any one of the coupling portion and the slide portion has a holding portion holding one of the coupling portion and the slide portion into another.

7. A siding boards attachment structure as claimed in claim 5, wherein the J-Channel fixes the fixing plate portion and the movable front surface plate portion to each other by a fixing means.
